(19) United States
(12) Patent Application Publication
(10) Pub. No.: US 2022/0005333 A1
(43) Pub. Date: Jan. 6, 2022

(54) Smart Security Monitoring Device and System

(71) Applicant: Patrick Arnold, Melbourne, FL (US)

(72) Inventor: Patrick Arnold, Melbourne, FL (US)

(21) Appl. No.: 17/367,292

(22) Filed: Jul. 2, 2021

Related U.S. Application Data
(60) Provisional application No. 63/047,780, filed on Jul. 2, 2020.

(51) Int. Cl. G08B 13/196

(52) U.S. Cl. CPC G08B 13/19621; G08B 13/19628; G08B 13/19689; G08B 13/19645; G08B 13/1961

(57) ABSTRACT

Disclosed is a smart security monitoring device and system.

The current application claims a priority to the U.S. provisional patent application Ser. No. 63/047,780 filed on Jul. 2, 2021.

### FIELD OF THE INVENTION

The present invention relates generally to a security monitoring device and a security camera system. More specifically, the present invention relates to a multi-functional security monitoring device and a security monitoring system that includes a plurality of the security monitoring device. The present invention is specifically designed for providing effective security monitoring for residential premises. However, the present invention is not limited to this option, and it may further be adapted for different purposes.

### BACKGROUND OF THE INVENTION

Nowadays, video security systems are widely used for security monitoring and surveillance in any type of facility, in order to ward off criminals, monitor building premises, and record footage of events if necessary. A typical video security system comprises a plurality of security cameras that are located around an area, such as at each corner of a residential building. These cameras connect into a closed circuit television network that transmits the captured image data to a television monitor for real-time viewing or to a recording device (or a could server) for storage.

However, several drawbacks are associated with the existing video security systems and camera devices. For example, existing video security systems usually serve the sole purpose of monitoring a specific area. Typically, responsive to detecting unauthorized entry and/or movement at a house or business, the system generates an audible alarm and/or notify the user of the unauthorized entry and/or movement. The user cannot effectively interact with the video security system. Moreover, existing camera devices normally have a limited field of view (“FOV”) and thus cannot cover a larger area than what may be covered by the FOV. Furthermore, many camera devices are unable to identify a moving object (e.g., a person) and keep track of the moving object. The present invention aims to solve some of these problems by disclosing a smart security monitoring device and system.

### SUMMARY OF THE INVENTION

A first aspect of the present invention provides a smart security monitoring device that can be installed at a location of interest. The smart security monitoring device has a unique design such that it can provide a wider FOV. Moreover, the smart security monitoring device is provided with a plurality of light illuminators that are capable of being oriented to a moving object such that high-quality images may be captured. A second aspect of the present invention provides a security monitoring system that comprises a plurality of the smart security monitoring devices described herein.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. It should be noted that the drawings are schematic and not necessarily drawn to scale. Some drawings are enlarged or reduced to improve drawing legibility.

FIG. 1 is a perspective view of the smart security monitoring device of the present invention.

FIG. 2 is another perspective view of the smart security monitoring device of the present invention.

FIG. 3 is yet another perspective view of the smart security monitoring device of the present invention.

FIG. 4 is a front view of the smart security monitoring device of the present invention.

FIG. 5 is a rear view of the smart security monitoring device of the present invention.

FIG. 6 is a top view of the smart security monitoring device of the present invention.

FIG. 7 is a bottom view of the smart security monitoring device of the present invention.

FIG. 8 is a right-side view of the smart security monitoring device of the present invention.

FIG. 9 is a perspective view of the smart security monitoring device of the present invention, in which the main body of the smart security monitoring device is tilted about 45 degrees.

FIG. 10 is a perspective view of the smart security monitoring device of the present invention, in which the main body of the smart security monitoring device is tilted about 90 degrees.

FIG. 11 is a block diagram illustrating the architecture of the smart security monitoring device of the present invention.

FIG. 12 is a schematic diagram illustrating the security monitoring system of the present invention.

### DETAIL DESCRIPTIONS OF THE INVENTION

The foregoing and other objects and advantages will appear from the description to follow. It is to be understood, however, that the present invention may be embodied in various forms. These embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense.

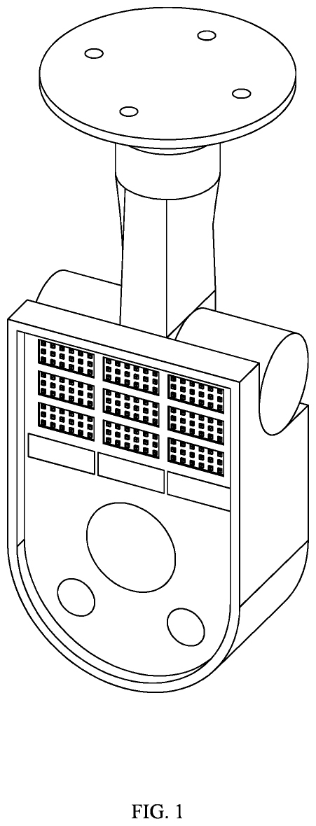

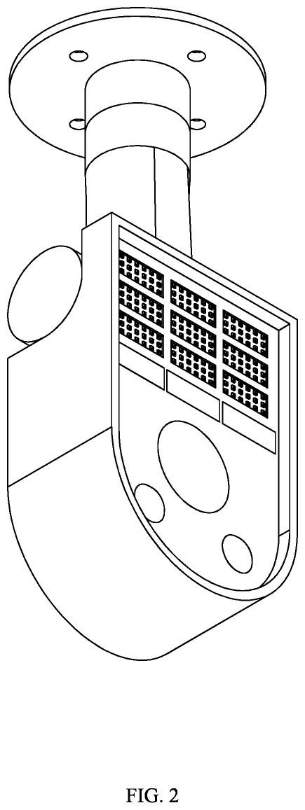

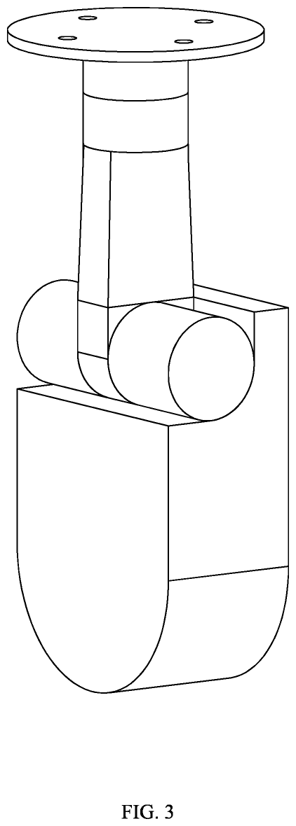

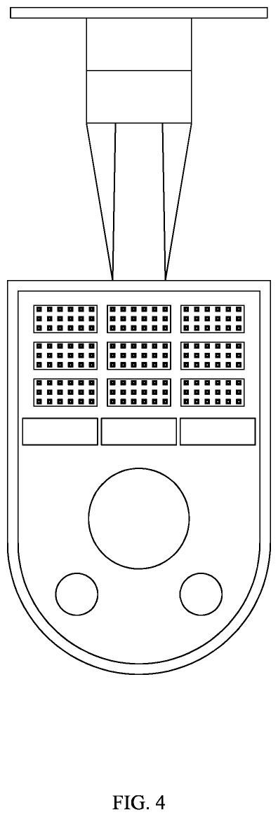

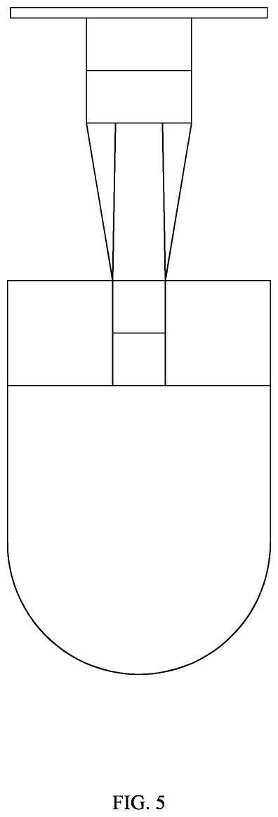

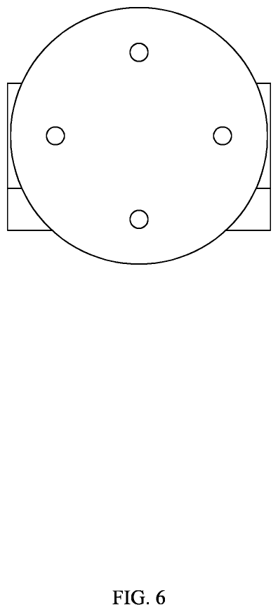

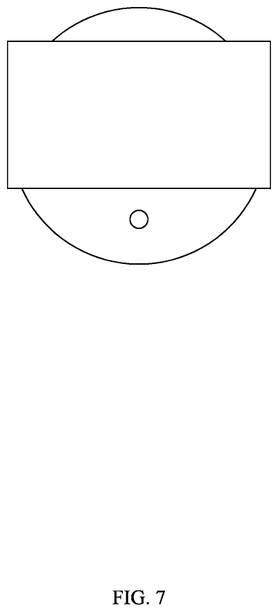

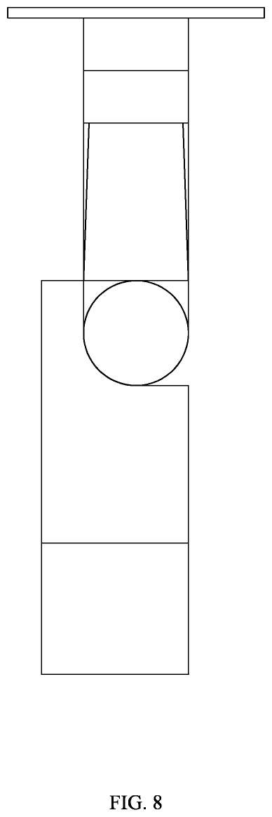

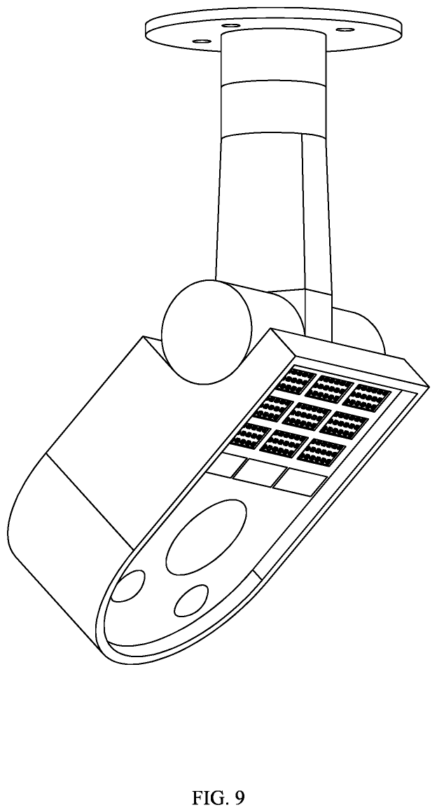

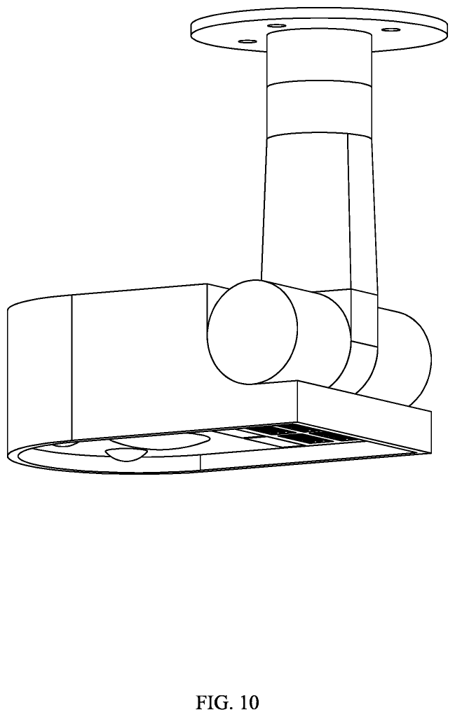

In reference to FIGS. 1-12, the present invention is designed for security monitoring and surveillance. In a first aspect of the present invention, a smart security monitoring device comprises a main body that is equipped with a plurality of electronic components, and a mount. In a second aspect of the present invention, a security monitoring system comprises a plurality of the smart security monitoring devices of the present invention. It is an aim of the present invention to provide a monitoring device having a broader and deeper FOV. It is another aim of the present invention to provide a novel smart security monitoring device that can identify and keep track of a moving object. It is yet another aim of the present invention to provide a security monitoring system that allows a user to remotely control and interact with a plurality of the smart security monitoring devices.

In reference to FIGS. 1-10, the main body is attached to the mount such that the main body can rotate 360° horizontally and tilt 90° backward and upward. It should be noted that the main body can be of any shape, size, material, features, type or kind, orientation, location, quantity, components, and arrangements of components that would allow the present invention to fulfill the objectives and intents of the present invention. In the illustrated embodiment, the main body comprises a vertical post and a horizontal post. The horizontal post is arranged on the top portion of the main body and connected to an end of the vertical post in such a way that the horizontal post and thus the main body may be tilted 90° backward and upward. The other end of the vertical post is connected to the mount such that the vertical post can rotate 360° about its longitudinal axis. Appropriate drive mechanisms (e.g., actuators, motors, etc.) may be housed in the vertical and/or horizontal posts to provide rotation and tilting capabilities.

In the illustrated embodiment, the mount comprises a mount base that is disk-shaped and provided with a plurality of mounting holes. However, it should be noted that the mount can be of any shape, size, material, features, type or kind, orientation, location, quantity, components, and arrangements of components that would allow the present invention to fulfill the objectives and intents of the present invention.

Although in the illustrated embodiment the main body is shaped like a rectangle with a curved bottom, any other suitable shapes are also contemplated. In the illustrated embodiment, the main body defines a recessed front surface on which a plurality of light illuminators, a plurality of sensors, and a plurality of cameras are provided. The plurality of light illuminators, the plurality of sensors, and the plurality cameras can be arranged at any suitable location on the front surface. Other necessary components may be housed in the main body.

The plurality of light illuminators may be oriented to project visible light in a certain direction, such that when the light illuminators are turned on, the resulting light beams create a spotlight that tracks the moving object by rotating and tilting the main body. The plurality of sensors may comprise any suitable sensors, including but not limited to a motion sensor, a smoke sensor, a temperature sensor, a humidity sensor, etc. The plurality of cameras is configured to capture images of the area of interest. The cameras may be visible-light digital cameras, infrared cameras, or any other suitable cameras. In the illustrated embodiment, the plurality of cameras comprises a primary camera and two secondary cameras for capturing higher-definition images.

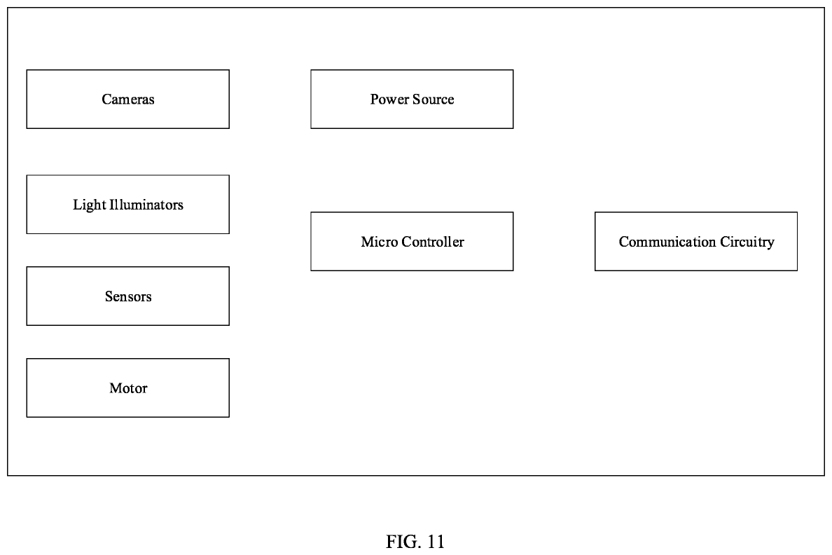

In reference to FIG. 11, the main body further comprises a controller, a storage medium, a communication circuitry, and a power source. The controller is configured to receive signals generated and data collected by the sensors, process the signals and data, and control other components (e.g., light illuminators, cameras, motors, etc.,) based on the received signals and data. In a preferred embodiment, the motion sensor is used to identify a moving object, and in response to detecting the moving object, generate a signal that instructs the controller to turn on the cameras and the light illuminators. The controller may be further configured to control the motor to rotate and tilt the main body based on the signal generated by the motion sensor so as to keep track of the moving object. In this way, when the user walks into the monitoring area, the spotlight can follow the user and illuminate his path as he enters or leaves the house. Also, the spotlight formed by the light illuminator allows the cameras to capture sharper and clearer images.

The communication circuitry is configured to interface and communicate with other external devices (e.g., servers, user devices, etc.). The communication circuitry may be configured to support various communication standards and protocols for home networking, for camera networking, for wireless networking (e.g., the IEEE 801.11 Wi-Fi standards, the Bluetooth™ standard, the ZigBee™ standard), for general wired networking (e.g., Ethernet), and/or for other types of networking.

The storage medium may include one or more memory devices or electro-mechanical storage devices and associated logic (e.g., implemented in hardware, software, or a combination of both) for storing and accessing data and information (e.g., video footage) in the one or more memory or electro-mechanical storage devices. The one or more memory or electro-mechanical storage devices may include various types of volatile and non-volatile memories and storages, such as a hard disk drive, a flash memory, a RAM (Random Access Memory), an EEPROM (Electrically-Erasable oRead-Only Memory), and other devices for storing digital information.

The power source is configured to provide electric power to the electronic components of the present invention. Preferably, the present invention may be a rechargeable battery. However, the present invention can also be powered via a wall outlet.

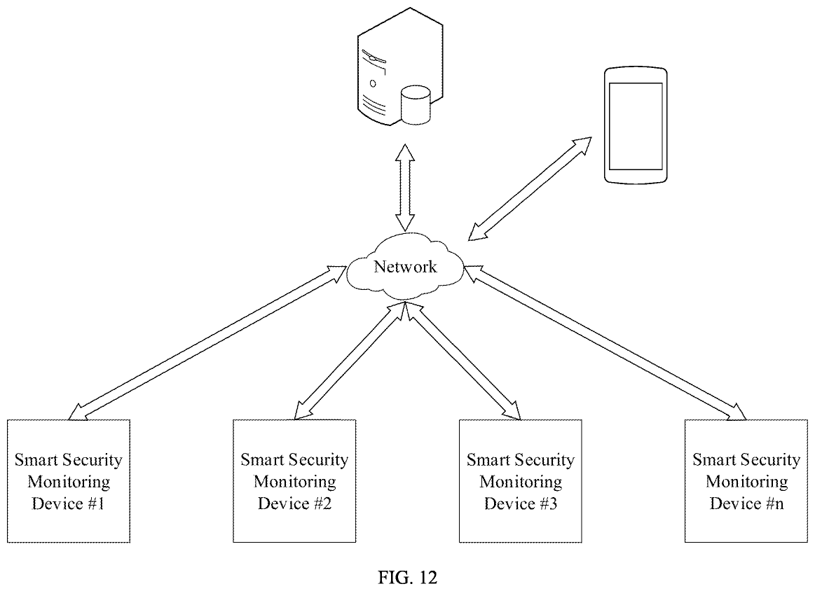

In reference to FIG. 12, the security monitoring system comprises a plurality of smart security monitoring devices described herein, one or more user devices (e.g., tablets, cellphones, laptops, etc.), and a server. A user may remotely control the plurality of smart security monitoring devices via an app installed on his/her user device. In a preferred embodiment, the user may link the system of the present invention to his social media account (e.g., Facebook), allowing the system to access the profiles (in particular the photos) of the user and his/her friends on the social media platform. In this preferred embodiment, the server is configured to use facial recognition technology to identify if a person captured by the camera is someone who the user knows or an intruder. If an intruder is identified, an alarm may be sounded to indicate that someone has entered the sensing area.

Although the invention has been explained in relation to its preferred embodiment, it is to be understood that many other possible modifications and variations can be made without departing from the spirit and scope of the invention.

What is claimed is:

1. A security monitoring system comprises:
At least one device unit;
the at least one device unit comprises a main body, a plurality of electronic components, and a mount;
the mount being externally connected to the main body;
the plurality of electronic components being integrated into the main body;
the plurality of electronic components being configured to monitor with a broader and deeper field of view (FOV);
the plurality of electronic components being configured to identify and track a moving object; and
the plurality of electronic components being configured to communicate and interact with a remote user control device.
